(19) United States
(12) Patent Application Publication
(10) Pub. No.: US 2017/0193753 A1
(43) Pub. Date: Jul. 6, 2017

(54) POKER GAME

(71) Applicant: Sheng-Huo CHENG, Taichung City (TW)

(72) Inventor: Sheng-Huo CHENG, Taichung City (TW)

(21) Appl. No.: 14/845,490

(22) Filed: Sep. 4, 2015

Related U.S. Application Data
(60) Provisional application No. 62/178,912, filed on Apr. 22, 2015.

(51) Int. Cl. G07F 17/32

(52) U.S. Cl. CPC G07F 17/3293; G07F 17/3204; G07F 17/322; G07F 17/3225; G07F 17/3227; G07F 17/3239; G07F 17/3244; G07F 17/326; A63F 2001/005

(57) ABSTRACT

The present invention is a poker game which can be executed in a computer system or executed by a robot. This game includes a checked step, a private card dealing step, a public card dealing step, a first round comparing step, a second round comparing step and a final determination step. The player gets two private cards in the private card dealing step. The score of the two private cards is used to compare in the first round comparing step. The two private cards of player, one public card and the other two private cards of the computer (banker) are assembled and checked whether meet a special five card type in the second round comparing step.

### FIELD OF THE INVENTION

The invention relates to the technological field of a poker game, and more particularly to a poker or poker-like game having two rounds of comparing steps.

### RELATED ART

The typically known and frequently seen poker games comprise five-card draw, three-card poker, five-card stud, seven-card stud, Texas Hold'em, Black Jack and the like. Changes of these games usually relate to dealing and playing methods.

In China poker game, each player can get 13 cards from a deck of standard 52 cards. Each player must classify these cards into three hands including a front hand of three cards, a middle hand of five cards and a back hand of five cards. Thereafter, the players compare the front hand of cards, compare the middle hand of cards and compare the back hand of cards according to the standard poker rule.

### SUMMARY OF THE INVENTION

An object of the invention is to provide a poker game with the enhanced game interest and diversification.

In addition, a deck of physical poker cards or a computer system and terminal devices connected together can achieve the object of the method of the poker game of the invention.

Furthermore, the invention provides a poker game comprising, in order, a checking step, a private card dealing step, a public card dealing step, a first round comparing step, a second round comparing step and a final determination step. More particularly, different comparing methods are adopted in the first round comparing step and the second round comparing step, wherein one of the comparing methods is to compare the total scores, and the other of the comparing methods is to compare states constituting special card types. So, the game of the invention has two rounds of comparing steps, and has the effects of enhancing the game interest and diversification.

### BRIEF DESCRIPTION OF THE DRAWINGS

FIG. 1 is a schematic view showing positions of a banker and players playing a game of the invention using a deck of physical poker cards.

FIG. 2 is a schematic block diagram showing steps of the invention.

FIG. 3 is a schematic view showing a checking step of the invention.

FIG. 4 is a schematic view showing a private card dealing step of the invention.

FIG. 5 is a schematic view showing a public card dealing step of the invention.

FIG. 6 is a schematic view showing a first round comparing step of the invention.

FIG. 7 is a schematic view showing a second round comparing step of the invention.

FIG. 8 is a schematic view showing configurations of the invention applied to a computer system and terminal devices.

FIG. 9 is a schematic view showing contents displayed on the terminal devices according to the invention.

FIG. 10 is a schematic view showing a state of the first round comparing step displayed on the terminal device of the player X according to the invention.

FIG. 11 is a schematic view showing a state of the first round comparing step displayed on the terminal device of the player Y according to the invention.

FIG. 12 is a schematic view showing a state of the second round comparing step displayed on the terminal device of the player X according to the invention.

FIG. 13 is a schematic view showing a state of the second round comparing step displayed on the terminal device of the player Y according to the invention.

FIG. 14 is a schematic view showing a state of the second round comparing step displayed on the terminal device of the player Z according to the invention.

FIG. 15 is a block diagram showing steps comprising a betting step according to the invention.

### DETAILED DESCRIPTION OF THE INVENTION

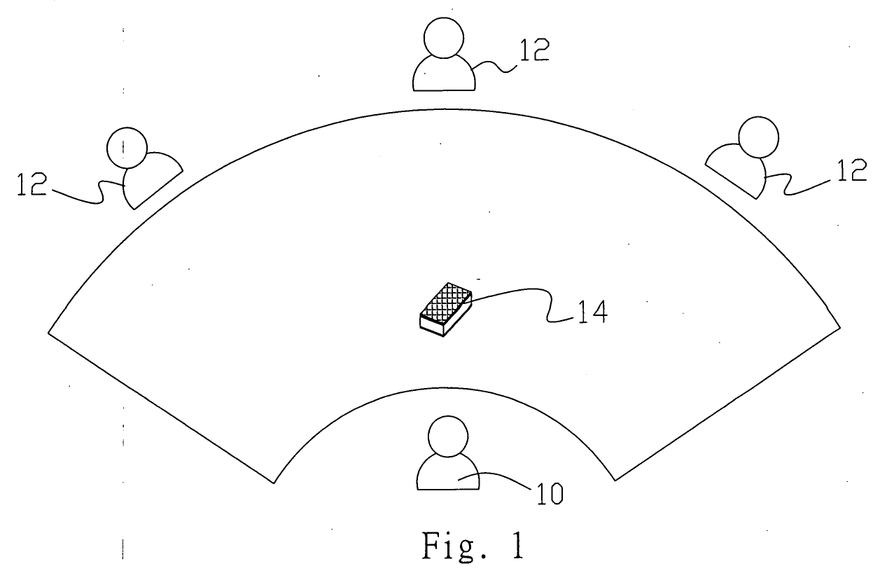

Referring to FIG. 1, the poker game of the invention is executed by a banker (10) and multiple players (12) using a deck of physical poker cards (14). The deck of poker cards (14) is a deck of standard poker cards comprising 52 cards (A [symbol] to K [symbol] , A [symbol] to K [symbol] , A♡ to K♡ and A♦ to K♦). Furthermore, the number of players (12) is preferably smaller than or equal to 7.

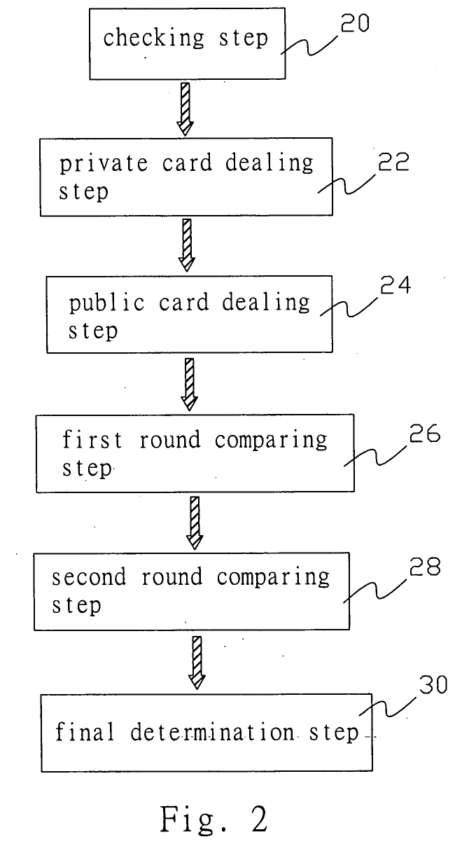

Referring to FIG. 2, the game of the invention comprises a checking step (20), a private card dealing step (22), a public card dealing step (24), a first round comparing step (26), a second round comparing step (28) and a final determination step (30).

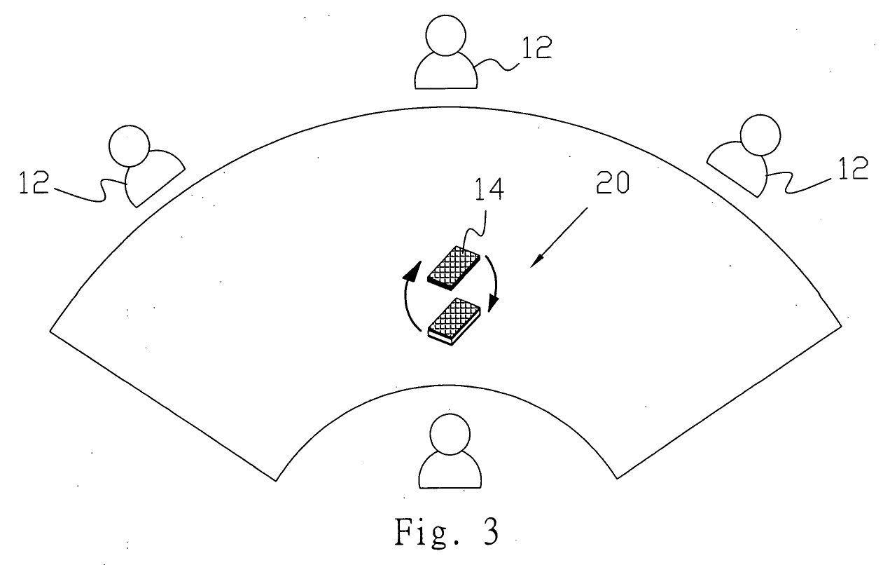

Referring to FIGS. 2 and 3, the checking step (20) is to let an arbitrary player (12) adjust the placement position (or stacking order) of at least one card of the deck of poker cards (14). For example, as shown in the drawing, the player divides the deck of poker cards (14) into upper and lower portions, and exchanges the positions of the upper and lower portions with each other, or the user draws a topmost card of the deck of poker cards (14) and places the topmost card under the bottommost card.

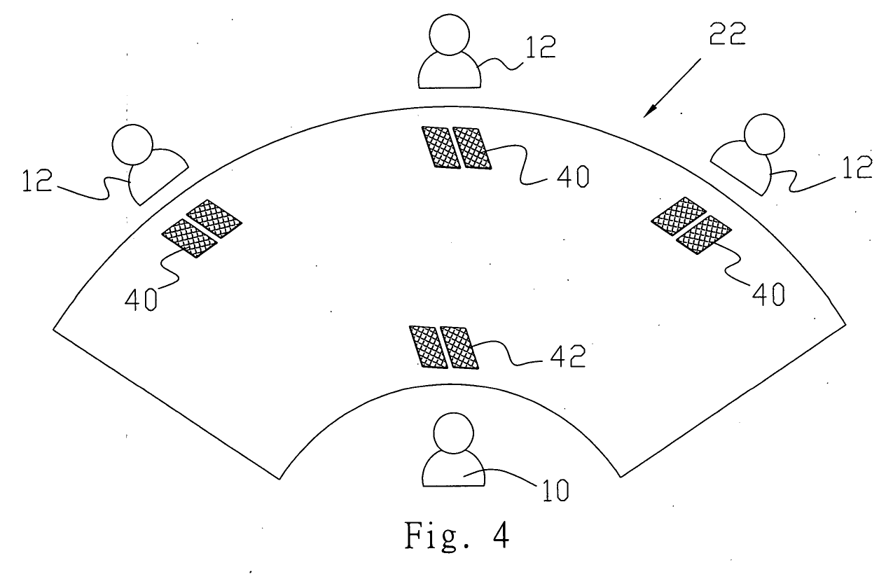

Referring to FIGS. 2 and 4, the private card dealing step (22) comprises a first round dealing step and a second round dealing step. The first round dealing step is to deal a first card to each player (12) firstly and to the banker (10) finally in a predetermined order. The second round dealing step repeats the first round dealing step in the predetermine order. Thus, each player (12) obtains two folded private cards (40), and the banker (10) obtains two folded private cards (42). The checking step (20) may be executed by an arbitrary player (12) before the private card dealing step (22) is executed.

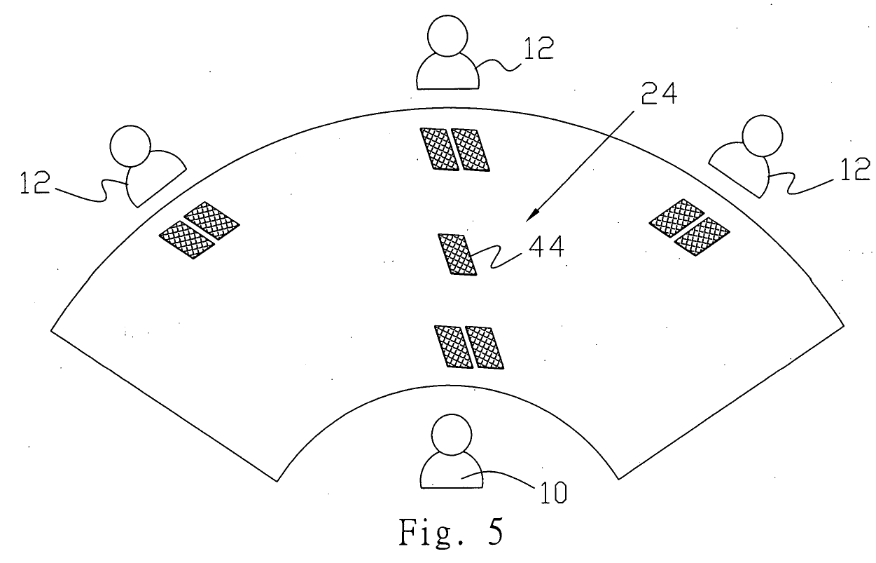

Referring to FIGS. 2 and 5, the public card dealing step (24) is to deal one public card (44), which does not belong to the banker (10) and each player (12), wherein the public card (44) is folded.

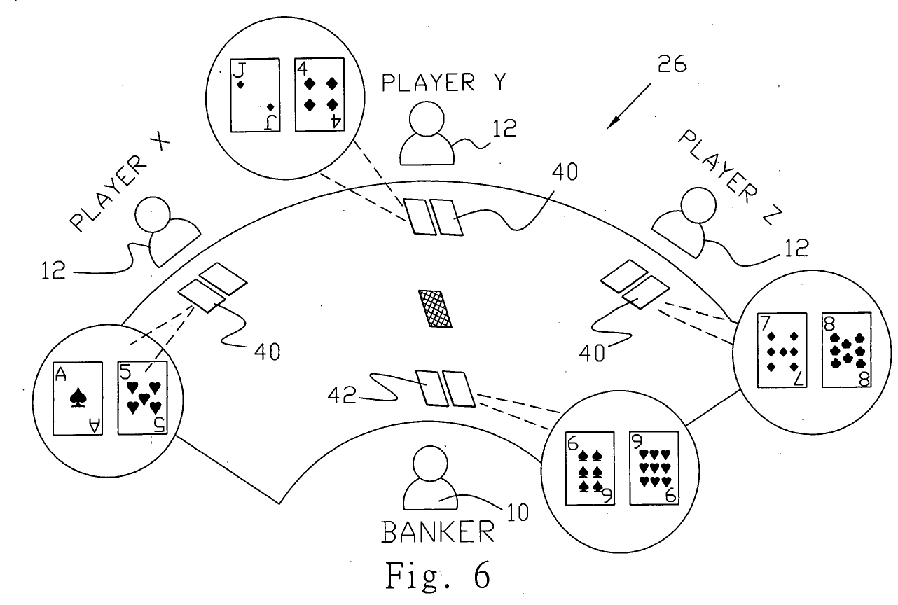

Referring to FIGS. 2 and 6, in the first round comparing, step (26), the banker (10) opens the private card (42), and each player (12) opens his/her two private cards (40). The banker and the players summate the scores of the private cards (40) and (42). The scores of the cards are listed in the following Table 1.

TABLE 1

| Card | Corresponding score |
|---|---|
| A | 1 |
| 2 | 2 |
| 3 | 3 |
| 4 | 4 |
| 5 | 5 |
| 6 | 6 |
| 7 | 7 |
| 8 | 8 |
| 9 | 9 |
| 10 | 0 |
| J | 0 |
| Q | 0 |
| K | 0 |

That is, no matter which suit (spade, club, heart or diamond) is present, the cards A to 9 correspond to the scores 1 to 9, respectively, and the cards 10, J, Q and K correspond to the score 0.

If the total score of the private cards (40) and (42) is higher than or equal to 10, then 10 is subtracted from the total score, so that each of the scores of the banker and the players ranges from 0 to 9. For example, the player X has two private cards (40) of cards A and 5, so the total score of the player X is equal to 6 (=1+5). The player Y has the cards J and 4, so the score of the player Y is equal to 4 (=0+4). The player Z has the cards 7 and 8, so the counted score of the player Z is equal to 15 (=7+8). However, the sum is higher than 10 and the score of the player Z is equal to 5 (=15−10). The private cards (42) of the banker are the cards 6 and 9, so the score of the banker is equal to 15 (=6+9), and the counted score of the banker is equal to 5 (=15−10). In this round, the total score of the player (12) is higher than that of the banker 10, and the player (12) is the winner in the first round. That is, the player X is the winner, while the players Y and Z are losers in this round. In other words, the rule of the first round comparing step (24) resides in that the score of the player must be higher than that of the banker to win this game, and the player will lose the game even if the scores of the players and the banker are the same.

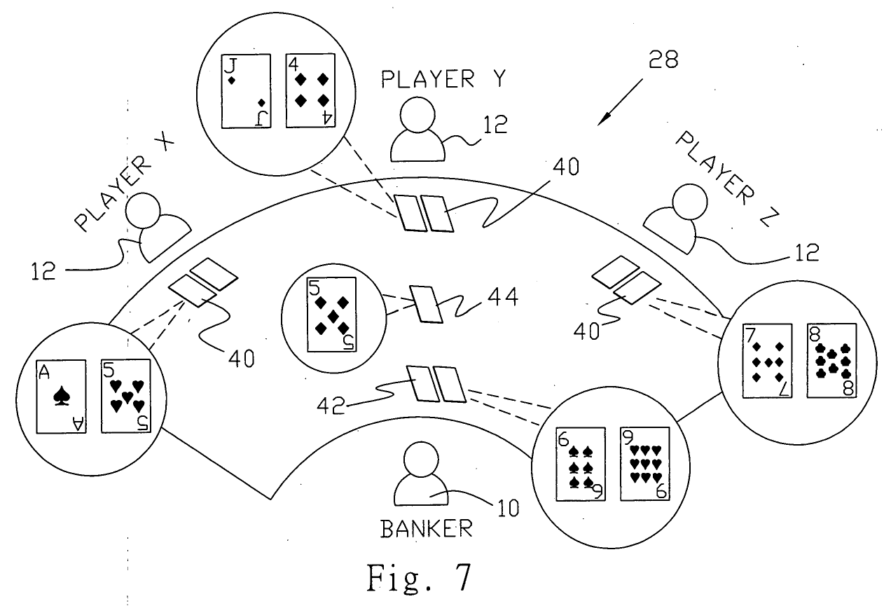

As shown in FIGS. 2 and 7, the second round comparing step (28) is executed after the first round comparing step (26). The second round comparing step (28) opens the public card (44) after the first round comparing step (26) is completed. Next, each player (12) combines his/her own two private cards (40), the public card (44) and the two private cards (42) of the banker together to obtain a five-card type. If the five-card type satisfies a special card type, then the player is the winner. The special card type comprises one pair, two pairs, three of a kind, straight, flush, full house, four of a kind, straight flush and royal flush. The above-mentioned “one pair” is only applicable to one pair of Ace, one pair of King, one pair of Queen and one pair of Jack. In addition, each special card type may be assigned with different odds according to the actual situation of the game, and the definitions of the special card types may be increased or decreased.

According to the above-mentioned descriptions and drawings, the player X has the two private cards (40) being the cards A [symbol] and 5♡, and the public card (44) being the card 5♦, while the banker (10) has the private cards (42) being the cards 9♡ and 6 [symbol] . So, the player X can obtain one pair of 5, but not one pair of A, K, Q or J, and cannot become the winner in the second round comparing step (28).

The player Y has the two private cards (40) being the cards J♦ and 4♦, and the public card (44) being the card 5♦, while the banker (10) has the private cards (42) being the cards 9♡ and 6 [symbol] . The player Y has the five-card type, which does not satisfy the requirement of the special card type, so the player Y is still the loser in this round.

The player Z has the two private cards (40) being the cards 7♦ and 8 [symbol] , and the public card (44) being the card 5♦, while the banker (10) has the private cards (42) being the cards 9♡ and 6 [symbol] . The combination of the five-card type of the player Z satisfies the “straight” in the special card type, so the player Z is the winner in this round.

In the final determination step (30) of the invention after the first round comparing step (26) and the second round comparing step (28) are executed, if the player (12) has the score higher than that of the banker (10) in the first round comparing step (26) and the requirement of the special card type is not satisfied in the second round comparing step (28), then the player (12) is judged as the winner in the first round comparing step (26). If the player (12) has the score higher than that of the banker (10) in the first round comparing step (26), and the requirement of the special card type is satisfied in the second round comparing step (26), then the player is judged as the winner in the second round comparing step (26), If the player (12) has the score lower than that of the banker (10) in the first round comparing step (26), and the requirement of the special card type is not satisfied in the second round comparing step (28), then the banker (10) is the winner.

For example, when the player X is the winner in the first round comparing step (26) but is not the winner in the second round comparing step (28), the player X is finally determined as the winner in the first round comparing step (26), and the odds follow the rules in the first round comparing step (26).

Also, when the player Y is the loser in both the first round comparing step (26) and the second round comparing step (28), the player Y is finally determined as the loser.

When the player Z is the loser in the first round comparing step (26) but is the winner in the second round comparing step (28), the player Z is finally determined as the winner in the second round comparing step (28), and the odds follow the rules in the second round comparing step (28).

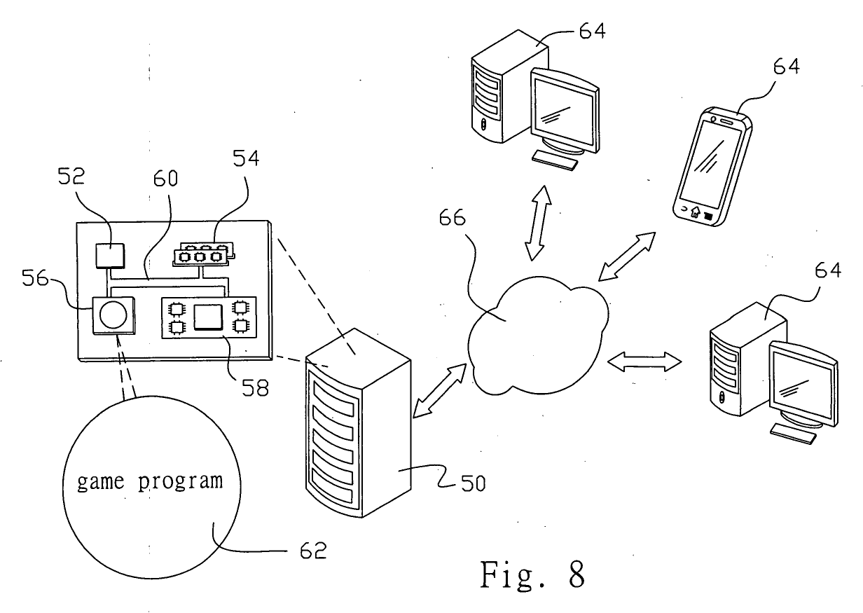

Referring to FIG. 8, a computer system (50) and a plurality of terminal devices (64) can be connected together through a network (66). The computer system (50) may comprise a processor (52), a memory (54), a storage device (56) and an input/output apparatus (58), which are electrically connected together—through a suitable bus (60). It is worth noting that an executable game program (62) is installed in the storage device (56). The network (66) may be the wired/wireless Ethernet or Internet.

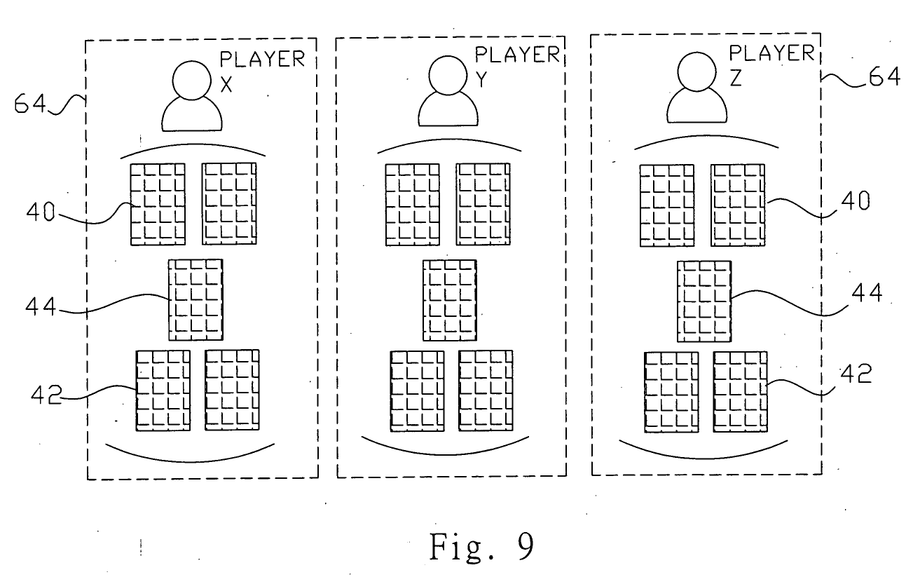

Referring to FIGS. 8 and 9, when the computer system (50) is connected to each of the terminal devices (64) and the game program (62) is executed, the terminal devices (64) may be operated by the players X, Y and Z, respectively. The terminal device (64) operated by each player may display two sets of two private cards (40) and (42) and one public card (44) that can be selected, wherein the private cards (40) and (42) and the public card (44) are folded. Thus, according to the above-mentioned contents, the game program (62) can execute the checking step (20), the private card dealing step (22) and the public card dealing step (24) of FIG. 2 of this invention. The player at the terminal device (64) can arbitrarily select one or two sets of the private cards.

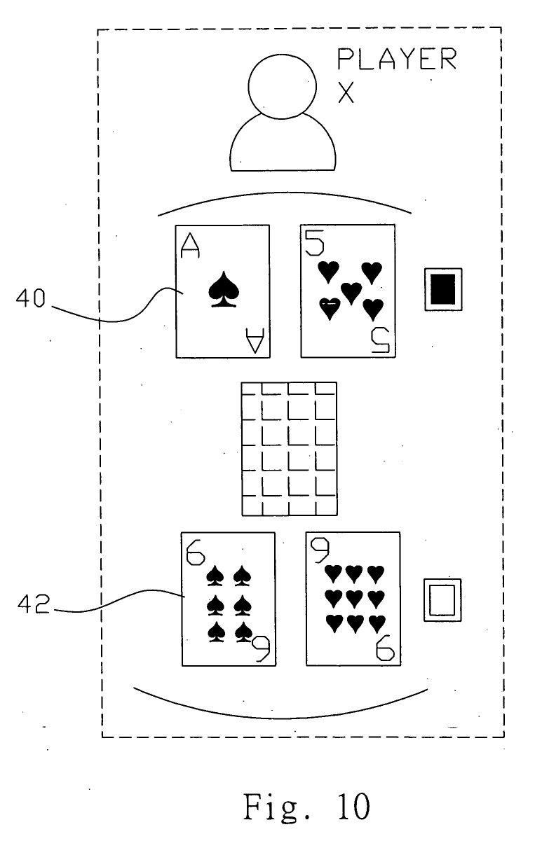

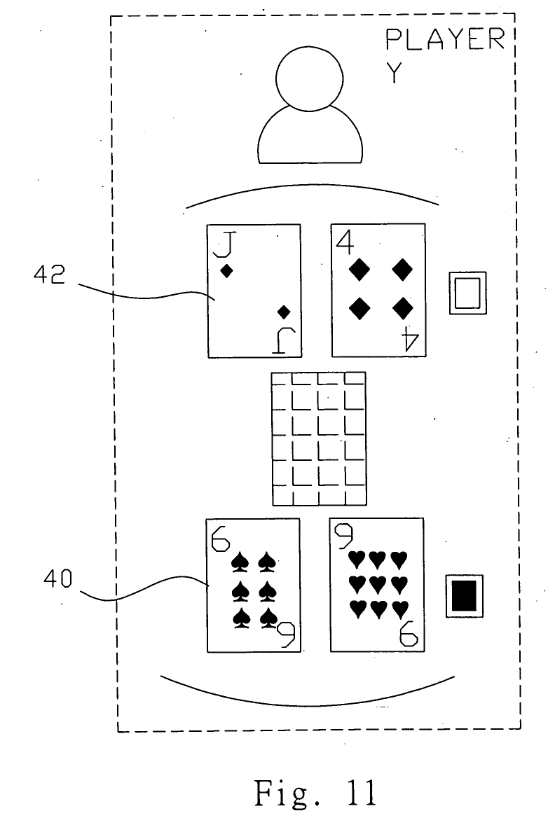

As shown in FIG. 10, for example, the player X selects one set of the private cards (40). Then, the private cards (40) of the player X and the other set of private cards (42) can be opened, and the total scores can be compared with each other. If the total score of the private cards (40) is higher than the total score of the private cards (42), then the player X is judged as the winner. Referring to FIG. 11, the player Y selects one set of private cards (40). Then, the private cards (40) of the player Y and the other set of private cards (42) can be opened, and the total scores can be compared with each other. If the total score of the private cards (40) is equal to the total score of the private cards (42), then the player Y is judged as the loser. FIGS. 10 and 11 show the first round comparing step of the invention.

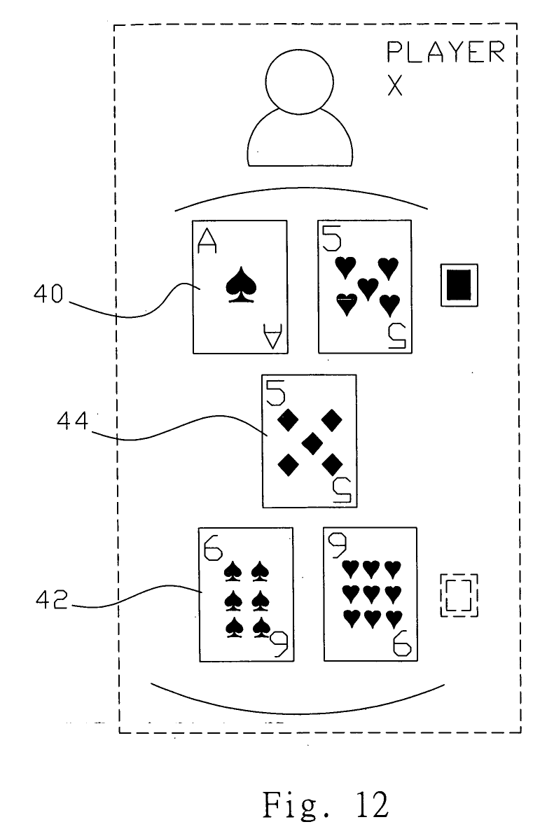

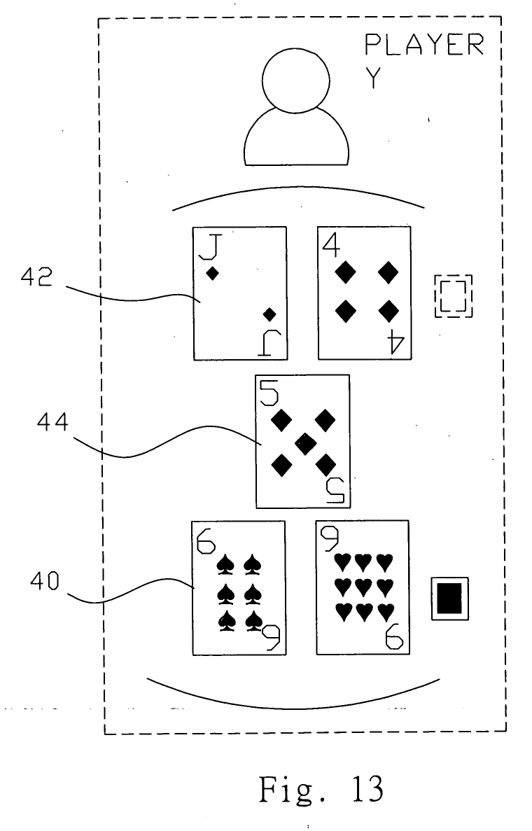

As shown in FIGS. 12 and 13, after the public cards (44) of the players X and Y are opened, two sets of private cards (40) and (42) and one public card (44) can be combined. In other words, FIGS. 12 and 13 show the second round comparing step of the invention, and whether the player X or the player Y wins is determined according to the rules of the above-mentioned special card type.

It is worth noting that the private cards (40) and (42) and the public card (44) are only described for the illustrative purpose only. Because each terminal device is an independent apparatus, the private cards (40) and (42) and the public card (44) obtained by each player may be the same as or different from those obtained by another player.

As mentioned hereinabove, the player selects one set of private cards to be possessed by himself or herself, and the selected private cards are compared with the other set of unselected private cards, and further combined with the unselected private cards and the public card. Thus, the above-mentioned operation mode satisfies the first round comparing step (26), the second round comparing step (28) and the final determination step (30) shown in FIG. 2 of the invention.

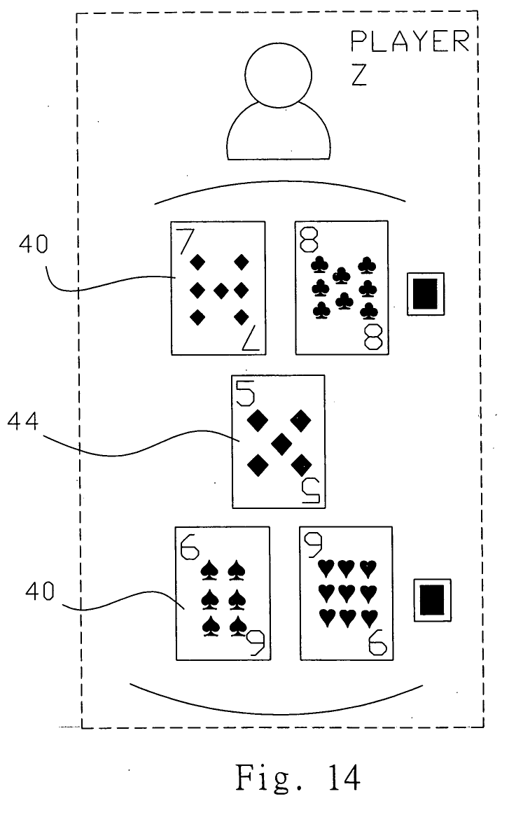

Referring to FIG. 14, the player Z can select two sets of private cards (40) at the same time. Because there is no other set of private cards to be compared, all the private cards (40) and the public card (44) have to be opened in this mode, and the comparison of the special card type is executed. If the special card type can be established, then the player Z is determined as the winner, or otherwise as the loser.

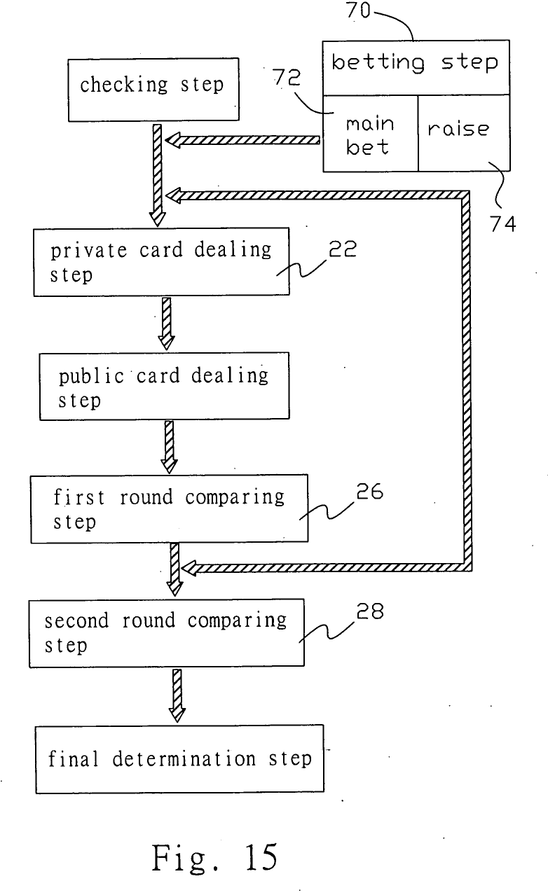

Referring to FIG. 15, the invention further has a betting step (70) applicable to the above-mentioned embodiments. Furthermore, the betting step (70) comprises betting a main bet (72) and betting a raise (74). The-betting step (70) comprises four modes, wherein the first mode is to bet the main bet (72) only, the second mode is to bet the raise (74) only, the third mode is to bet the main bet (72) and the raise (74) concurrently, and the fourth mode is to bet the main bet (72) firstly and then to bet the raise (74).

The betting behavior of the main bet (72) in the first mode is executed before the private card dealing step (22) is executed, or before the first round comparing step (26) is executed.

The betting behavior of the raise (74) in the second mode must be executed before the private card dealing step (22) is executed.

The betting behavior of the main bet (72) and the raise (74) in the third mode may be concurrently executed before the private card dealing step (22) is executed, or before the first round comparing step (26) is executed.

The betting behavior of the main bet (72) in the fourth mode is executed before the private card dealing step (22) is executed or before the first round comparing step (26) is executed. The betting behavior of the raise (74) is executed after the first round comparing step (26) is executed, and before the second round comparing (28) is executed.

It is worth noting that each player can select a betting mode. However, when the fourth mode is to be selected, the raise (74) must be smaller than the main bet (72). In addition, the win or loss of the main bet (72) is determined according to the result of the first round comparing step (26). The win or loss of the raise is determined according to the result of the second round comparing step.

For example, FIGS. 10 and 11 only show the form of betting the main bet. If the main bet and the raise need to be betted, the public card may be further opened to form the conditions shown in FIGS. 12 and 13. If only the raise is to be betted, then all the cards can be opened concurrently to form the condition shown in FIG. 14.

In this invention, the game can be played using a deck of physical poker cards, or using a deck of physical poker cards in conjunction with a robot for dealing the card, or using an electronic/computer apparatus and a game program. So, the effect of enhancing the enforceability of the game can be obtained. Next, the game of the invention has two rounds of comparing steps, and the two comparing steps are based on different contents (one is based on the total score, and the other is based on the special card type). So, this game has the enhanced interest and diversification.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A poker game method played by one banker and players according to one deck of 52 standard poker cards, the poker game comprising:
a private card dealing step comprising a first round dealing step and a second round dealing step, wherein the first round dealing step is to deal a first card to each of the players first and then the banker in a predetermined order; the second round dealing step is to repeat the first round dealing step in the predetermined order, so that each of the banker and the players obtains two folded private cards;
a public card dealing step of dealing one public card, which does not belong to the banker and the players, wherein the public card is folded;
a first round comparing step of opening the two private cards of each of the banker and the players, and to summate scores of the two private cards of each of the banker and the players, wherein cards A to 9 respectively correspond to the scores 1 to 9, and cards 10, J, Q and K correspond to the score 0, wherein if a total score of the two private cards is higher than or equal to 10, then 10 is subtracted from the total score so that the score of each of the banker and the players ranges from 0 to 9, wherein the scores of the banker and the players are compared with one another;
a second round comparing step of opening the public card after the first round comparing step is completed, wherein each of the players combines the two private cards of the player, the public card and the two private cards of the banker into a five-card type, wherein if the five-card type satisfies a special card type, then the player is determined as a winner;
a final determination step executed after the first round comparing step and the second round comparing step, wherein:
if the score of the player is higher than the score of the banker in the first round comparing step, and a requirement of the special card type is not satisfied in the second round comparing step, then the player is judged as the winner in the first round comparing step;
if the score of the player is higher than the score of the banker in the first round comparing step, and the requirement of the special card type is not satisfied in the second round comparing step, then the player is judged as the winner in the second round comparing step; and
if the score of the player is lower than the score of the banker in the first round comparing step, and the requirement of the special card type is not satisfied in the second round comparing step, then the banker is judged as the winner.

2. The poker game method according to claim 1, further comprising a checking step, in which one of the players adjusts a stacking order of at least one card of the deck of poker cards before the private card dealing step is executed.

3. The poker game method according to claim 1, further comprising a betting step of betting a main bet before the private card dealing step is executed, wherein whether the main bet wins or loses is determined according to a result of the first round comparing step.

4. The poker game method according to claim 1, further comprising a betting step of betting a main bet and a raise at different timings, wherein the raise is lower than the main bet, the main bet is executed before the private card dealing step, and whether the main bet wins or loses is determined according to a result of the first round comparing step; and a betting behavior of the raise is executed after the first round comparing step is completed and before the second round comparing step is executed, wherein whether the raise wins or loses is determined according to a result of the second round comparing step.

5. The poker game method according to claim 1, further comprising a betting step of betting a main bet and a raise concurrently, wherein betting behaviors of the main bet and the raise are executed before the private card dealing step, whether the main bet wins or loses is determined according to a result of the first round comparing step, and whether the raise wins or loses is determined according to a result of the second round comparing step.

6. A poker game apparatus, comprising:
a computer system;
a plurality of terminal devices connected to the computer system via a network, wherein each of the terminal devices corresponds to one player;
a game program installed in the computer system, the game program executing the following steps and determinations of:
(a) displaying, on each of the terminal devices, two sets of private cards and public cards, wherein each of the sets of the private cards and the public cards comprises two private cards and one public card, and the four private cards and the public cards are folded;
(b) enabling each of the players to select one set of private cards or two sets of private cards, wherein in a mode of selecting the one set of private cards, a first round comparing step can be executed, or the first round comparing step can be executed first and then a second round comparing step is executed; and the second round comparing step can be executed in a mode of selecting the two sets of private cards, wherein:
in the first round comparing step, a total score of the selected set of private cards is compared with a total score of the unselected set of private cards after being opened;
in the second round comparing step, all of the private cards and the public cards are combined to form a combined card type, and whether the combined card type satisfies a requirement of a special card type is determined;
(c) judging the player as a winner in the first round comparing step if the total score of the selected private cards is higher than the total score of the unselected private cards in the first round comparing step, and the requirement of the special card type is not satisfied in the second round comparing step; judging the player as the winner in the second round comparing step if the total score of the selected private cards is higher than the total score of the unselected private cards in the first round comparing step, and the requirement of the special card type is satisfied in the second round comparing step; and judging the player as a loser if the score of the player is lower than the score of the banker in the first round comparing step, and the requirement of the special card type is not satisfied in the second round comparing step does not satisfy.

7. The poker game apparatus according to claim 6, wherein cards A to 9 of the two private cards respectively correspond to the scores 1 to 9, and card 10, J, Q and K correspond to a score of zero; and if the total score of the two private cards higher than or equal to 10, then 10 is subtracted from the total score so that the scores of the two private cards range from 0 to 9.

8. The poker game apparatus according to claim 6, wherein the steps further comprise a betting step of betting a main bet before the first round comparing step, wherein whether the main bet wins or loses is determined according to a result of the first round comparing step.

9. The poker game apparatus according to claim 6, wherein the steps further comprise a betting step of betting a main bet and a raise at different timings, wherein the raise is lower than the main bet, the main bet is executed before the first round comparing step is executed, and whether the main bet wins or loses is determined according to a result of the first round comparing step; and a betting behavior of the raise is executed after the first round comparing step is completed and before the second round comparing is executed, and whether the raise wins or loses is determined according to a result of the second round comparing step.

10. The poker game apparatus according to claim 6, wherein the steps further comprise a betting step of concurrently betting a main bet and a raise, wherein betting behaviors of the main bet and the raise are executed before the first round comparing step, whether the main bet wins or loses is determined according to a result of the first round comparing step, and whether the raise wins or loses is determined according to a result of the second round comparing step.
